(19) United States
(12) Patent Application Publication
(10) Pub. No.: US 2026/0368653 A1
(43) Pub. Date: Nov. 19, 2026

(54) Unsupervised Group Modeling

(71) Applicant: PayPal, Inc., San Jose, CA (US)

(72) Inventors: Jiadong Chen, Shanghai (CN); Yingying Yu, Shanghai (CN); Jiaqi Zhang, Shanghai (CN)

(21) Appl. No.: 19/448,545

(22) Filed: Jan. 14, 2026

(30) Foreign Application Priority Data
May 14, 2025 (WO) PCT/CN2025/094832

(51) Int. Cl. G06N 20/20

(52) U.S. Cl. CPC G06N 20/20

(57) ABSTRACT

Techniques are disclosed relating to modeling group patterns for evaluating electronic communications, in which a computer system receives, from a client computing device, a request to initiate electronic communications. The computer system may compare a plurality of characteristics of the electronic communications with group pattern models. The computer system may generate the group pattern models by generating groups of graph nodes within a graph generated from historical electronic communications and calculating an ensemble score for respective groups based on one or both of group information features and distribution features. The computer system may further generate the group pattern models by generating, based on the ensemble scores calculated for respective groups, the plurality of group pattern models, where groups are used to generate the group pattern models. The computer system may transmit, to a client computing device, a decision for the request based on results of the comparing.

### PRIORITY CLAIM

The present application claims priority to PCT Appl. No. PCT/CN2025/094832, entitled “UNSUPERVISED GROUP MODELING”, filed May 14, 2025, which is incorporated by reference herein in its entirety.

### BACKGROUND

### TECHNICAL FIELD

This disclosure relates generally to techniques for identifying anomalies in data, and, more specifically, to detecting patterns in groups of similar data.

### DESCRIPTION OF THE RELATED ART

In data processing scenarios, particularly scenarios in which a system is processing vast amounts of data, often referred to as “big data,” the ability to distinguish meaningful information from the data is important. However, processing large amounts of data is often cumbersome and identifying patterns within the data becomes computationally expensive. In order to make sense of or identify useful information from big data, existing systems often employ various machine learning models. For example, machine learning models are often utilized to identify emerging trends in data over time. After identifying such trends in the data, systems often utilize the trends to make decisions, including performing actions or further evaluation of specified portions of the data based on the identified trends. In various situations, a system may utilize a supervised or semi-supervised machine learning model to proactively identify drifts or alerts from data. Further, the system may automatically address identified emerging trends and mitigate loss or data security breaches caused by sudden spikes or changes indicated by the identified emerging trends in the data. As one specific example, an electronic communication processing system might identify, using a machine learning model, that newly received electronic communication requests are similar to risky communications previously identified by the processing system. In the context of supervised machine learning, the electronic communication processing system may train a machine learning classifier using labeled “bad” or “risky” communications, such that the classifier is able to identify new communications that are similar to those previously identified, and labeled accordingly. Such techniques often involve a feedback loop in which the newly received communications are, in turn, labeled (e.g., manually labeled) and utilized to retrain or update an existing machine learning model.

### BRIEF DESCRIPTION OF THE DRAWINGS

FIG. 1 is a block diagram illustrating an example computer system configured to model group behavior for electronic communication decisioning, according to some embodiments.

FIG. 2 is a block diagram illustrating an example graph module, according to some embodiments.

FIG. 3 is a block diagram illustrating an example group scoring module, according to some embodiments.

FIG. 4 is a diagram illustrating example communication distributions, according to some embodiments.

FIG. 5 is a block diagram illustrating example online and offline processing, according to some embodiments.

FIG. 6 is a diagram illustrating example group pattern models, according to some embodiments.

FIG. 7 is a flow diagram illustrating an example method for real-time predictions for electronic communications using previously generated group pattern models, according to some embodiments.

FIG. 8 is a flow diagram illustrating an example method for generating and utilizing group patterns for electronic transaction decisioning, according to some embodiments.

### DETAILED DESCRIPTION

Communication processing systems generally receive requests to initiate some action (i.e., a communication) and then perform an evaluation of the requests prior to transmitting a response to such requests. For example, if an end user requests to initiate an electronic transaction, then an electronic transaction processing system first evaluates the requested transaction (e.g., to determine risk associated with the transaction) and then transmits a response to the end user’s device based on the evaluation. Traditionally, communication processing system performs this evaluation using a machine learning model trained on labeled historical communications in a supervised or semi-supervised manner. Such traditional techniques, however, are often labor intensive or computationally expensive. Further, traditional evaluation techniques fail to provide insight for new activity. This new activity may include requests that have not been seen before for a given account or entity within a communication processing system. As one specific example, a “first-time” invoice from a new account is often approved by traditional evaluation techniques due to the lack of historical activity for this new account. Traditional machine learning techniques are often not able to accurately identify anomalous behavior for this account, since they have not yet been trained on activity of this particular account.

To address the label and historical data dependency problem within the realm of machine learning and the corresponding delays in the production of labels for training data described above, the disclosed techniques implement an unsupervised prediction system that does not rely on labeling. Rather than relying on the slow, labor intensive process of generating labels for historical electronic communications and then using these labeled communications to train machine learning models, the disclosed techniques provide pattern-based predictions. These pattern-based predictions are both unsupervised and based on the latest trends in an ever-changing dataset. Specifically, the disclosed techniques include group detection within a network graph generated based on a given dataset, group scoring based on a plurality of different group features, and group pattern modeling based on trends in high scoring groups.

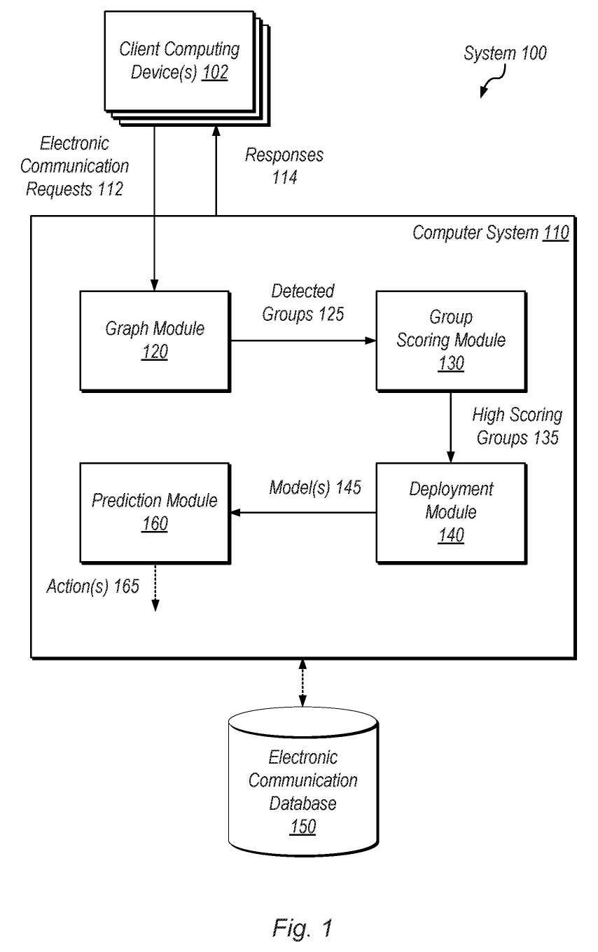

As discussed in further detail below with reference to FIG. 1, the disclosed system generates a heterogenous network graph from a plurality of historical electronic communications. These communications may include transactions (e.g., person-to-person transactions, invoices, bank transfers, etc.), server-to-server transmissions with a network of servers, messaging platform communications (e.g., email, text messages, social media messaging, etc.), or any of various types of electronic communications. This graph includes nodes representing different entities and variables involved in or corresponding to the historical electronic communications. Accordingly, by comparing different variables within nodes of the graph, the disclosed system identifies similar groups of nodes. Using various feature generation techniques, the disclosed system scores different identified groups of nodes based on an ensemble of a set of different types of features for each group. These sets of features may include one or more of the following types of features: a distribution feature, a group information feature, and a domain feature. After generating an ensemble score for each identified group, the disclosed system selects the highest scoring groups (e.g., relative to an ensemble score threshold) and utilizes these groups to generate group pattern models.

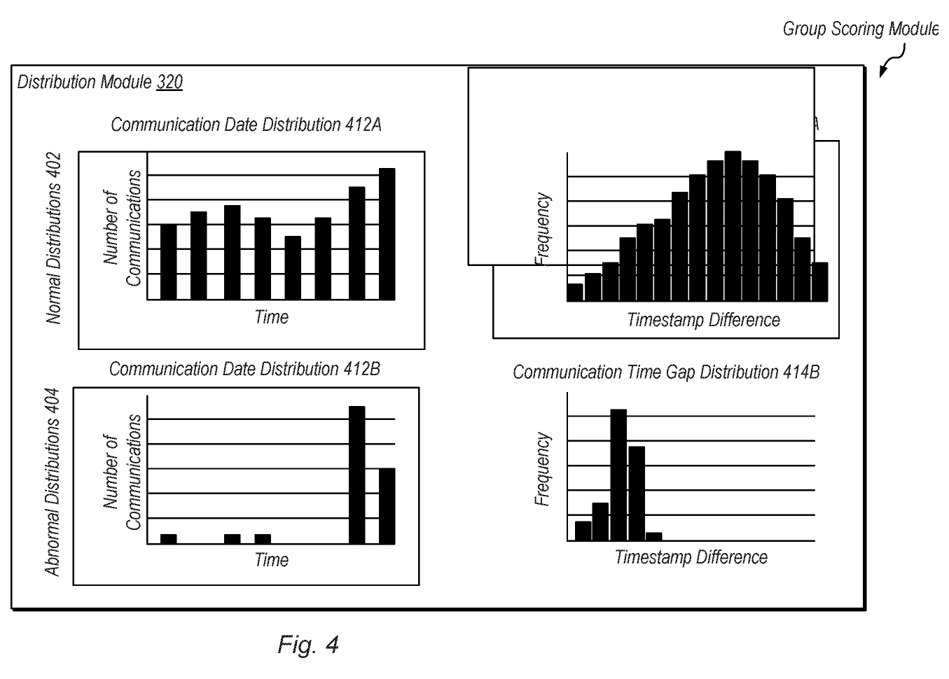

As used herein, the term “distribution feature” refers to a feature that indicates a distribution of a given variable corresponding to a set of electronic communications over time. For example, a first type of distribution feature is a date distribution feature indicating the distribution of timestamps of electronic communications. A second type of distribution feature is a time gap distribution feature indicating the distribution of time between electronic transactions. Example distribution features are discussed in further detail below with reference to FIG. 4.

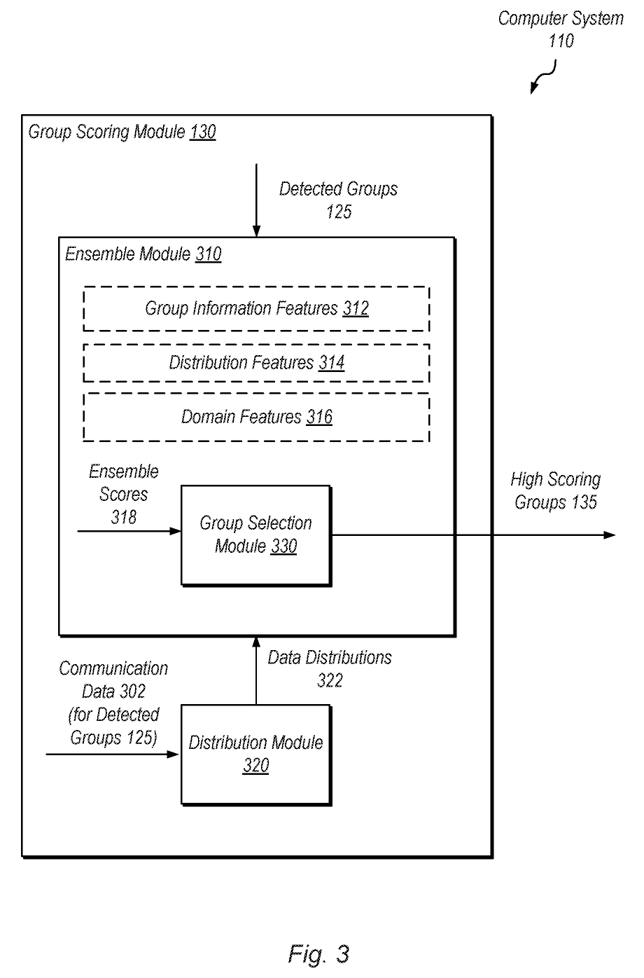

As used herein, the term “group information feature” refers to a feature indicating characteristics of a given group of electronic communications as a whole. For example, a first type of group information feature indicates a total number of entities included in a given group. A second type of group information feature indicates a total number of accounts in a given group. Example group information features are discussed in further detail below with reference to FIG. 3.

As used herein, the term “domain feature” refers to a feature corresponding to either new information in a given group or domain characteristics of the given group. For example, a first type of domain feature indicates a rate at which new entities are added to a given group. A second type of domain feature indicates a rate at which random email addresses (e.g., gibberish or randomly entered names) are added to a given group. A third type of domain feature indicates a rate at which a country and Internet Protocol (IP) address match in respective nodes of a given group. Example domain features are discussed in further detail below with reference to FIG. 3.

In some embodiments, the disclosed group pattern model techniques may advantageously identify anomalous communication activity for new entities for which the system does not have a history of activity. In the context of the electronic communications being invoices, a detected group of similar nodes corresponding to similar invoices, likely includes invoices that are generated by the same entity. For example, a given entity (e.g., a malicious user) that recently created many new accounts, often using a script, with a traditional system is likely to send a large number of similar invoices within a short period of time to many different end users. In this example, because the entity recently created new accounts, these invoice are the first activity seen by the disclosed system from these account.

Using traditional evaluation techniques, first-time invoices are difficult to evaluate, since a pattern of behavior by these accounts has not yet been observed. This often leads traditional systems to allow these first invoices in order to observe these accounts’ behavior and to be able to generate labels for identifying anomalous behavior for these accounts. This, in turn, often results in loss both computationally and monetarily for the traditional systems since these invoices are fraudulent (e.g., when the traditional system executes these fraudulent invoices and then reimburses end users that received, and paid, these fraudulent invoices). In contrast to such traditional systems, the disclosed system is able, via group detection and pattern modeling, to quickly identify accounts within a given group that are sending a set of first-time invoices that are likely fraudulent. For example, in general, it is very unlikely that all or the majority of accounts within a given group are sending first-time invoices close together in time. The disclosed techniques quickly identify that this group of accounts belongs to the same entity and is, therefore, likely fraudulent.

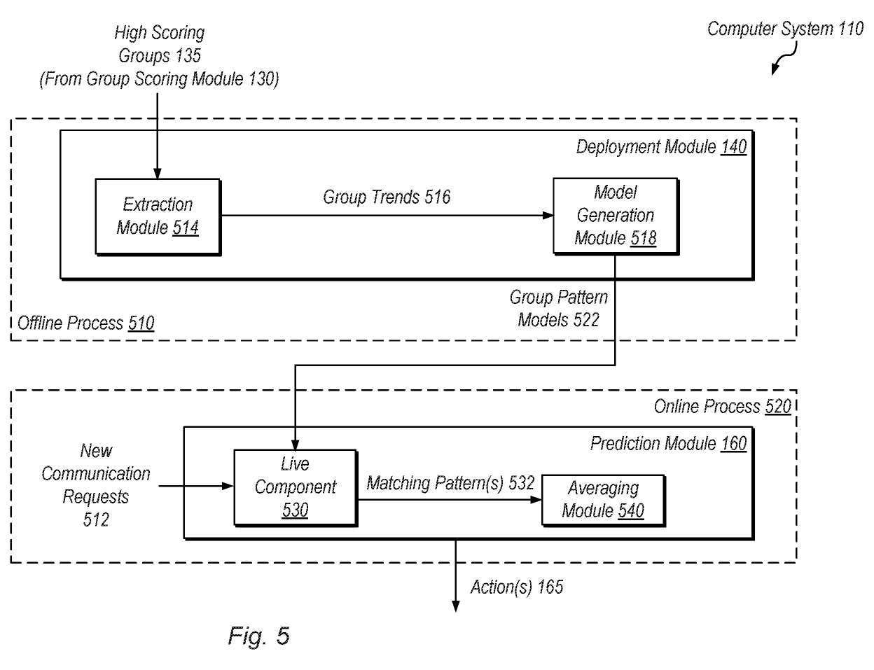

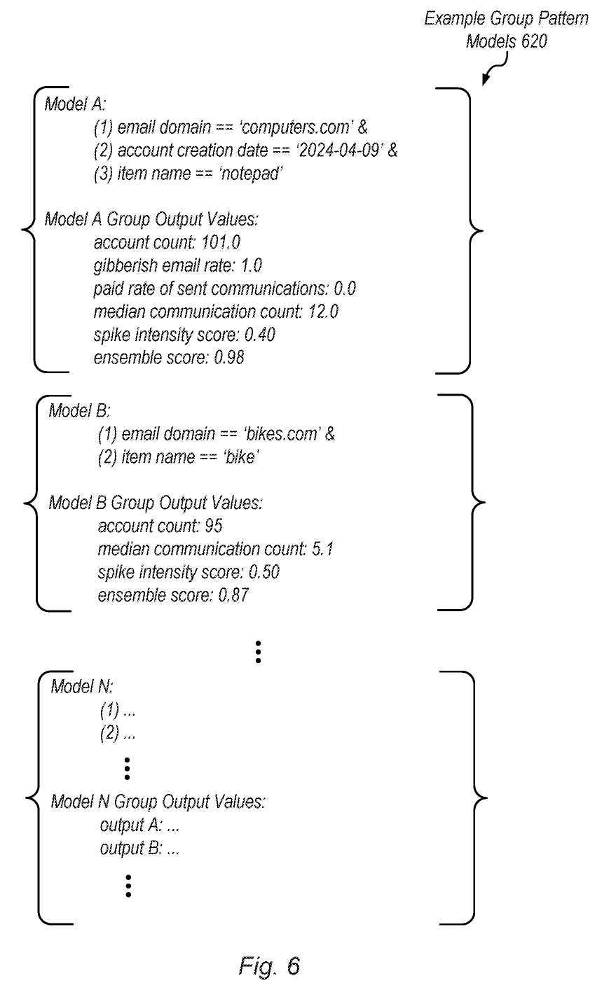

The disclosed group pattern modeling is performed in an offline manner, which advantageously allows a prediction system, trained on group pattern models as discussed in detail below with reference to FIGS. 1 and 5, to deploy in an online manner. For example, while traditional techniques often require manual and resource-intensive generation of labels for training a machine learning model, the disclosed techniques are implemented offline to generate group pattern models in an unsupervised manner. For example, as new electronic communication requests are received, the disclosed system quickly identifies whether the requests should be authorized (e.g., whether the requests are trustworthy or suspicious). In various embodiments, instead of simply embedding features for a given group, the disclosed system perform linking by extracting a trend from a group of nodes using JavaScript object notation (JSON) code that lists the variables for this group in a numerical format. The system then assigns a set of conditions to the trend, which includes a set of conditions to be used for comparison, as discussed in further detail below with reference to FIG. 6. For example, a direct embedding of group features is often not useful, because the system would be embedding values that are not numerical values. The disclosed features include categorical variables. Instead, the disclosed techniques generate conditions corresponding to the identified trends, where these conditions combine multiple features for this group under a JSON umbrella.

### Example Computer System

FIG. 1 is a block diagram illustrating an example computer system configured to model group behavior for electronic communication decisioning. In the illustrated embodiment, a system 100 includes one or more client devices 102, electronic communication database 150, and a computer system 110, which in turn includes graph module 120, group scoring module 130, deployment module 140, and prediction module 160.

Computer system 110, in the illustrated embodiment, receives electronic communication requests 112, from one or more client computing devices 102. In various embodiments, client devices 102 are end user devices, such as a mobile device (e.g., smartphone) or desktop computer, submitting requests to computer system 110 to perform an action, such as an electronic communication. In some embodiments, an end user utilizes their mobile device to submit a request for an electronic transaction. For example, a merchant may submit a request to complete an invoice to computer system 110 and computer system 110 processes the invoice. In other embodiments, client computing device 102 utilizes a cloud server to submit an electronic communication request (e.g., data transmission) to computer system 110. In such embodiments, the client computing device 102 and computer system 110 are part of a network of servers executed in a cloud environment.

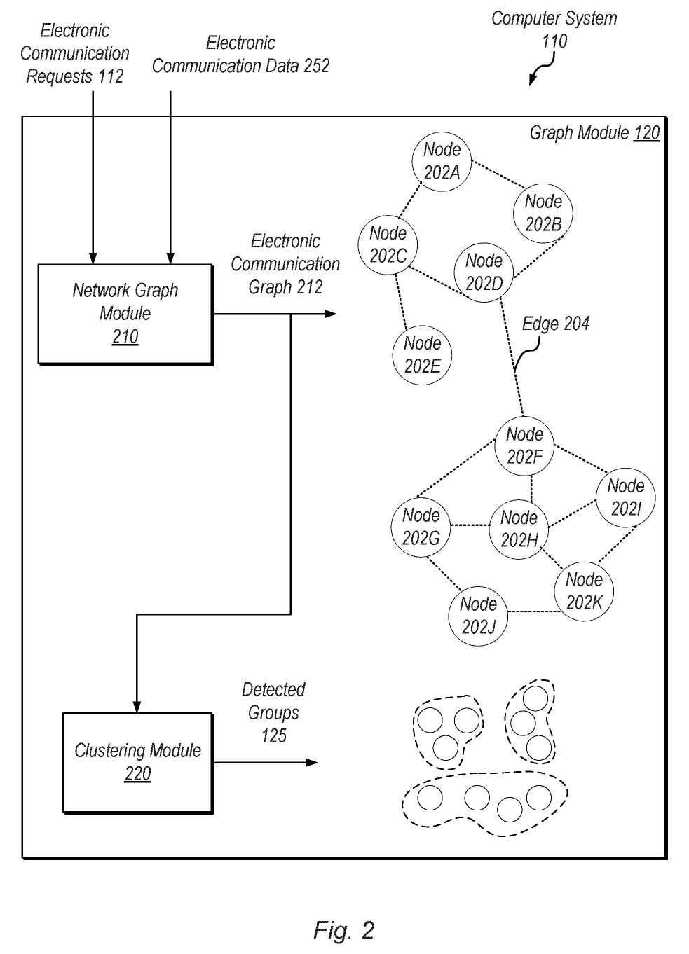

In the illustrated embodiment, computer system 110 executes graph module 120 to detects groups 125 based on a plurality of variables corresponding to electronic communication requests 112. For example, graph module 120 receives electronic communication requests 112 and detects groups 125 of requests 112 based on these requests being similar within a heterogenous variable space made up of requests 112. As discussed in further detail below with reference to FIG. 2, the heterogeneous space is made up of a plurality of different types of electronic communications, with many different variables for each electronic communication. For example, the heterogeneous variable space may be made up of 70 or more different types of nodes.

Group scoring module 130, in the illustrated embodiment, receives detected groups 125 from graph module 120. As discussed in further detail below with reference to FIG. 3, group scoring module 130 may generate a set of features for a given group that includes two or more of the following types of features: group information features, distribution features, and domain features. Group scoring module 130 generates a set of features for each of detected groups 125. Based on their respective sets of features, module 130 scores the detected groups 125. Group scoring module 130 identifies one or more high scoring groups 135 based on their scores and transmits these groups to deployment module 140.

Deployment module 140, in the illustrated embodiment, receives high scoring groups 135 from group scoring module 130. Deployment module 140 executes during an offline process to generate group patterns based on high scoring groups 135. As discussed in further detail below with reference to FIGS. 5 and 6, deployment module 140 identifies various conditions for a group pattern based on variables and one or more scores of a given high scoring group. These group patterns may also be referred to herein as “models” as shown in the illustrated embodiment. For example, deployment module 140 outputs one or more models 145 generated based on high scoring groups 135.

Prediction module 160, in the illustrated embodiment, utilizes model(s) 145 (i.e. the established group patterns) to identify whether newly received communication requests match the one or more models 145. Based on the evaluation of new requests 112 using the one or more models 145, prediction module 160 outputs one or more potential actions 165. For example, if a new communication request matches an established group pattern, then prediction module 160 predicts that the new request is suspicious and outputs an action 165. In this example, the action might include rejecting the new request. In various embodiments, computer system 110 performs one or more actions 165 output by prediction module 160 in response to new electronic requests 112. As shown in the illustrated embodiment, computer system 110 performs an action 165 that includes transmitting a response 114 to a client computing device 102 based on output of prediction module 160 for a request submitted by the client computing device 102.

As discussed in further detail below with reference to FIG. 5, computer system 110 executes graph module 120, graph scoring module 130, and deployment module 140 in an offline manner (e.g., before processing electronic communication requests 112). For example, group patterns/models are identified ahead of requests to which they are compared. That is, a set of electronic communication requests 112 is utilized offline by computer system 110 to identify group model(s) 145. Then, at a later time, prediction module 160 executes online to compare future electronic communication requests to model(s) 145 to determine whether these requests should be approved, for example. In contrast, computer system 110 implements module 160 in an online manner (e.g., real-time with processing requests 112).

In the illustrated embodiment, computer system 110 stores information in and retrieves information from electronic communication database 150. For example, each electronic communication request 112 may have corresponding communication data such as an item specified in the request 112 or a device identifier (ID) for the client device 102 that submitted the request. In various embodiments, system 110 stores electronic communication requests 112 and their corresponding communication data, one or more models 145, and one or more actions 165 determined for the requests 112 based on the one or more models, one or more network graphs generated by graph module 120, etc. in database 150. In some embodiments, computer system 110 stores various communication data such as information corresponding to various entities submitting requests 112, including variables that make up a heterogenous network graph generated by graph module 120 and one or more features generated from the variables. For example, computer system 110 stores account information, such as an email domain, an account creation date, etc. in database 150.

Note that using the disclosed group detection techniques to predict anomalies in electronic communications, such as electronic transactions or invoices, is one non-limiting example embodiment of the type of data that may be analyzed and the corresponding decisioning that may be performed by various computer systems 110 (or other systems). In various embodiments, computer systems may perform group detection and corresponding decisioning on any of various types of data, including program code changes, server network communications, medical data, weather data, etc.

In this disclosure, various “modules” operable to perform designated functions are shown in the figures and described in detail (e.g., graph module 120, group scoring module 130 deployment module 140, prediction module 160, etc.). As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC. The term “engine” may also be used interchangeably with the term “module” herein. For example, as used herein, the term “replay engine” refers to a set of software instructions that are executable by a database system, such as computer system 110, for example.

### Example Graph Module

FIG. 2 is a diagram illustrating an example graph module. In the illustrated embodiment, graph module 120 includes network graph module 210 and clustering module 220. Graph module 120 executes these two additional modules 210 and 220 to generate a network graph for a plurality of electronic communications. Graph module 120 detects various groups of nodes within the network graph. The term “group” may also be referred to herein as a “cluster,” which is intended to be construed according to its well-understood meaning, including a set of nodes that are grouped together based on similarities between nodes in the set.

Network graph module 210, in the illustrated embodiment, receives electronic communication requests 112 and electronic communication data 252 (e.g., retrieved from database 150 or included in requests 112) as inputs. Based on these requests and corresponding data 252, network graph module 210 generates a graph 212. In the illustrated embodiment, network graph module 210 provides graph 212 to clustering module 220. An example of network graph module 210 is shown in the right portion of FIG. 2. This example graph 212 is a heterogeneous, communication graph 212 made up of a plurality of nodes 202A-K and edges connecting the nodes. An example edge 204 is represented via a dotted line between node 202D and node 202F. Each edge in graph 212 represents an electronic communication occurring between two example nodes 202A-K. For example, electronic communication graph 212 includes nodes 202A, 202B, 202C, 202D, 202E, 202F, 202G, 202H, 202I, 202J, and 202K. In various embodiments, nodes 202A-202K include one or more of a plurality of node types corresponding to different types of communication data. For example, graph 212 is generated from 10, 50, 100, etc. different types of communication data variables.

Nodes 202A-202K, in the illustrated embodiment, correspond to one or more of the following types of communication data: a device fingerprint, context variables including text descriptions for an electronic communication (e.g., an invoice description), account profile keys, an electronic communication type (e.g., a person-to-person transaction, an invoice, a bank transfer, etc.), an email domain, an account creation date, an item corresponding to a transaction, a device identifier ID, and one or more entities involved in an electronic communication.

In some embodiments, electronic communication graph 212 includes nodes 202 corresponding to context characteristics, account profile key characteristics, and device characteristics. Device characteristics may be used to generate a fingerprint for a given device or server involved in an electronic communication. As one specific example, twenty-five context characteristics, five account profile key characteristics, and forty device characteristics are used to generate nodes 202 within graph 212. For example, the twenty-five electronic communication context characteristics include one or more of the following: billing address, billing email address, invoice dollar amount, due date, description of a product or service, etc. In this example, the five account profile key characteristics include one or more of the following: an email, an email domain, an account creation date, a first and last name, and a primary phone number. In some situations, the disclosed system uses an account creation date to detect whether an entity has generated multiple different accounts on the same day. For example, if a given entity utilizes a script to generate a large group of accounts at one time, this entity, and its corresponding large group of accounts, are likely suspicious.

The forty device characteristics discussed above may include one or more of the following: an IP address, a hash of a device identifier, a hash of a user’s fingerprint, an email address, a phone number, a time zone, a type of device, browser vs. application, browser version (Chrome, Firefox, etc.), a type of phone (e.g., iPhone or Android), pixels of the screen the entity is utilizing, a globally unique identifier (GUID), a device name, a country code, a language, a credit card number hash value, a first name, a last name, and a street address. While several example characteristics used to generate graph 212 are listed above, any of various additional characteristics corresponding to the plurality of electronic communication requests 112 may be used by computer system 110 to generate electronic communication graph 212.

In some embodiments, network graph module 210 assigns weights to edges 204 according to the linking strength between two nodes 202. For example, a weight is determined for an edge between two nodes of graph 212 based on a number of transactions occurring between and connecting two nodes. As one specific example, if two nodes are connected by three different edges (e.g., three different transactions), then the network graph module 210 assigns a weight value of three to this edge. In various other embodiments, network graph module 210 assigns different types of values to edges (e.g., non-integer values) to edges based on any of various methods of weight determination.

Clustering module 220, in the illustrated embodiment, receives electronic communication graph 212 from network graph module 210 and outputs a plurality of groups 125 detected within graph 212. In various embodiments, clustering module 220 detects one or more groups of nodes within graph 212, based on similarities between nodes 202. Clustering module 210 performs this detection using a graph community detection algorithm designed for large, heterogeneous networks. For example, clustering module 220 detects groups (also referred to as communities) of interconnected nodes within graph 212 using a Louvain algorithm. In other situations, clustering module 220 detects groups using a Leiden algorithm. Example detected groups of interconnected nodes are shown in the bottom right portion of FIG. 2 within graph module 120. In various embodiments, graph module 120 outputs detected groups 125, which are then scored by group scoring module 130 to identify one or more high scoring groups 135, as shown in FIG. 1 and discussed in further detail below with reference to FIG. 3.

### Example Group Scoring Module

FIG. 3 is a block diagram illustrating an example group scoring module. In the illustrated embodiment, group scoring module 310 includes distribution module 320 and ensemble module 310, which in turn includes group selection module 330. In various embodiments, computer system 110 executes group scoring module 130 to determine one or more groups of nodes from a network graph that are high scoring groups 135 (as shown in FIG. 1).

Ensemble module 310, in the illustrated embodiment, receives detected groups 125 (determined by graph module 120 as shown in FIG. 1) and generates a set of features for each of detected groups 125. For example, each set of features includes two or more of: group information features 312, distribution features 314, or domain features 316. In various embodiments, group scoring module 130 generates group information features 312, distribution features 314 (via distribution module 320), and domain features 316 via one or more preprocessing procedures. Once the set of features is generated by group scoring module 130, these features are input to ensemble module 310 along with their corresponding detected groups 125. As discussed above, group information features 312 may include features such as a number of entities included in a given group and a number of accounts in a given group. For example, group scoring module 130 determines the total number of entities in a given detected group 125. As another example, group scoring module 130 determines the total number of accounts in the given detected group 125. Similarly, domain features 316 may include features such as a rate at which new entities are added to a given group 125. For example, group scoring module 130 determines this rate based on communication data 302 for historical communications included in the given detected group 125.

As shown in the illustrated embodiment, group scoring module 130 executes distribution module 320 to determine data distributions 322 for detected groups 125 based on communication data 302 for historical communications. For example, distribution module 320 determines communication date distributions and communication time gap distributions for each of detected groups 125. Distribution module 320 determines these distributions based on the corresponding communication data 302 for historical electronic communications included in the detected groups. Data distributions 322 are discussed in further detail below with reference to FIG. 4. Distribution module 320 provides these data distributions 322 to ensemble module 310 for inclusion in distribution features 314 for detected groups 125. Distribution features 314, in turn may be used by ensemble module 310 to calculate ensemble scores 318.

In the illustrated embodiment, ensemble module 310 calculates ensemble scores 318 based on the sets of different features for each of detected groups 125. For example, ensemble module 310 inputs a set of features for a given detected group 125 of nodes 202 into a classification model, which outputs a classification score (one example of an ensemble score 318) for the given detected group 125. In some embodiments, ensemble module 310 calculates ensemble score 318 based on two of the same type of feature. For example, an ensemble score 318 might be generated based on two different group information features 312, such as a number of users in a group and a number of accounts in the group. In other embodiments, ensemble module 310 calculates ensemble score 318 based on at least two different types of features. For example, ensemble score 318 is calculated based on a distribution feature 314 (e.g., date distribution) and a domain feature 316 (e.g., gibberish email rate).

In some embodiments, ensemble module 310 executes a machine learning classifier (not shown) to generate an ensemble score that is between 0 and 1. For example, an ensemble score 318 close to 1 indicates that this entity is suspicious, while an ensemble score 318 close to 0 indicates that this entity is not suspicious. In other embodiments, any of various types of machine learning models may be used to generate ensemble scores 318 for detected groups 125 based on their corresponding features. For example, ensemble module 310 might execute a regression machine learning model instead of a classifier.

While in some embodiments ensemble module 310 generates ensemble scores 318 based on multiple features 312, 314, or 316, in other embodiments an ensemble score is generated based on a single one of features 312, 314, and 316. As one specific example, if more than a threshold number (e.g., 70% or more) of the email addresses within a given detected group 125 are gibberish email addresses, then ensemble module 310 generates an ensemble score 318 indicating that entities in this group are suspicious (e.g., fraudulent or malicious in some way). Similarly, if a majority (e.g., 90% or more) of accounts within a detected group 125 have a credit card country that does not match the IP address country (e.g., based on the device identifier), then ensemble module 310 generates an ensemble score 318 indicating that accounts within this group are suspicious.

In the illustrated embodiment, ensemble module 310 inputs scores 318 into group selection module 330 to determine which of the detected groups 125 are high scoring groups 135. In some embodiments, group selection module 330 selects groups with ensemble scores 318 that meet an ensemble score threshold. For example, group selection module 330 selects three out of twenty detected groups 125 as high scoring groups 135, based on these groups having an ensemble score 318 that is greater than or equal to 0.8 (when the ensemble scores are generated based on a classification score scale of 0 to 1).

### Example Communication Distributions

FIG. 4 is a diagram illustrating example communication distributions. The illustrated embodiment includes example normal distributions 402 and abnormal distributions 404 for two different types or distributions: communication data distributions and communication time gap distributions. As shown in the illustrated embodiment, group scoring module 130 generates different types of distributions using distribution module 320 (shown in FIG. 3).

In the illustrated embodiment, the top left graph illustrates a normal distribution 402 of a communication date distribution 412A for various communications initiated over evenly spaced time intervals. In contrast, the bottom left graph illustrates an abnormal distribution 404 of a communication date distribution 412B for various numbers of communications over evenly spaced time intervals. As one non-limiting example, communication date distribution 412A may represent the distribution of invoices at different time intervals over a given period of time. The communication date distributions 412A and 412B are utilized to generate features, such as distribution features 314 discussed above with reference to FIG. 3, which in turn are utilized by ensemble module 310 to select high scoring groups 135.

In some embodiments, calculating distribution features 314 includes calculating a distribution of timestamps for different groups of graph nodes included in a graph of electronic communications (such as the network graph shown in FIG. 2). In some embodiments, a feature indicating the distribution of timestamps is calculated as a Gini coefficient. For example, a Gini coefficient may be calculated for a given group node using a communication date distribution 412A generated for the particular node. Accordingly, the Gini coefficient value for communication date distributions 412A and 412B will differ greatly. For example, a Gini coefficient value for a normal distribution, such as distribution 412A, may be a small number, while a Gini coefficient value for an abnormal distribution, such as distribution 412B, may be a larger number. As one non-limiting example, the Gini coefficient for communication date distributions 412A and 412B may represent the distribution of invoices (one example of an electronic communication) over a given period of time.

In the illustrated embodiment, the top right graph illustrates a normal distribution 402 of a communication time gap distribution 414A of communications. For example, the graph shown in the top right portion of FIG. 4 illustrates the timestamp difference between electronic communications occurring in a given group relative to the frequency at which communications are occurring (initiated) that correspond to a given timestamp. Said another way, a time gap distribution 414A represents an average of an amount of time between events (i.e., between electronic communications). This distribution is calculated by distribution module 320 using a Poisson process model. As shown in the illustrated embodiment, a normal communication time gap distribution 414A includes fairly consistent differences in the time gap frequency, while an abnormal distribution 404 includes sporadic differences in terms of the time gap frequency. As one specific example, a merchant may send invoices to its clients at regular intervals of time, such as once a month (as reflected in distribution 414A). In contrast, a suspicious (or even malicious entity) may send a large number of invoices all at one time or within a short period of time (as reflected in distribution 414B).

As one non-limiting example of the data distribution calculations performed by distribution module 320, a plurality of historical electronic communications, that are invoices, are utilized by computer system 110 (shown in FIG. 1) to generate a network graph, as discussed above with reference to FIG. 2. In this example, computer system 110 generates a network graph of that includes a detected group of two thousand “good” users that send out invoices and each of these “good” users are operating individually, such that the data distribution of the number of invoices sent versus the date it was sent is randomly and evenly distributed. In this example, the detected group of “good” users will have a date distribution similar to that shown in distribution 412A in FIG. 4. Further in this example, for a detected group of “bad” accounts, even if the accounts belong to the same entity, the distribution of the number of invoices sent versus the time at which they were sent is likely an uneven distribution. As discussed above, date distributions 412A and 412B are calculated using a Gini coefficient. The Gini coefficient for date distribution 412A will be a value closer to 0 (indicating an equal distribution), while the Gini coefficient for date distribution 412B will be a value closer to 1 (indicating an unequal distribution).

### Example Deployment and Processing Modules

FIG. 5 is a block diagram illustrating example online and offline processing. In the illustrated embodiment, computer system 110 executes an offline process 510 and an online process 520. In the illustrated embodiment, offline process 510 includes execution of a deployment module 140, which in turn includes execution of pattern extraction module 514 and model generation module 518. The output of the offline process 510, output by model generation module 518, is provided as input to online process 520. In the illustrated embodiment, online process 520 includes execution of prediction module 160, which in turn includes execution of live component 530 and averaging module 540. Online process 520, in the illustrated embodiment, produces one or more actions 165, shown in FIG. 1 and executed by computer system 110, in response to new communication requests 512.

Offline process 510, in the illustrated embodiment, begins with deployment module 140 inputting high scoring groups 135 (received from group scoring module 130, shown in FIGS. 1 and 3) into extraction module 514. In various embodiments, extraction module 514 extracts various group trends 516 from the high scoring groups 135. For example, a given group may have one or more characteristics, variables, or features which make up the “trend” for this group. As one specific example, a trend for a given group may indicate a number of accounts included in this group, a rate at which random email addresses were added to the group, a number of electronic communications initiated by entities in the given group, etc. These trends, paired with one or more conditions as discussed in further detail below, make up an overall pattern or model for the given group.

Model generation module 518, in the illustrated embodiment, receives group trends 516 and generates group pattern models 522 based on these trends. For example, model generation module 518 generates a set of conditions for a model based on a given group trend 516. This set of conditions includes one or more requirements that future electronic communication requests compared to a corresponding group pattern model must meet in order to be identified as a match for this pattern. Model generation module 518 provides group pattern models 522 to a live component 530 of prediction module 160. Live component 530 receives new communication requests 512 and determines one or more matching patterns 532 for requests 512. As discussed in further detail below with reference to FIG. 6, in addition to a set of conditions, a given group pattern model 522 includes at least the ensemble score 318 and one or more characteristics, variables, or feature values corresponding to a high scoring group 135. This information makes up the output values for the given group pattern model 522. Note that while the output of model generation module 518 is referred to as a “group pattern model,” the terms “group pattern” and “group pattern model” may be used interchangeably herein to specify a set of requirements and their corresponding output values.

Model generation module 518 generates group pattern models 522 using a pattern linking, which is a summary pattern that includes one or more conditions. A condition is a workaround for the groups, because it is difficult for computer system 110 to describe a group. For example, there are certain values that cannot be embedded, such as categorical features. For each condition in a model, the system compares a new communication. As shown in FIG. 6 and described below, some sets of conditions include three different criteria that have to be and some have sets of conditions include three different criteria, but only one has to be met. After comparing a given electronic communication with a set of conditions in a given model, if there is a match, then prediction module 160 selects an ensemble score assigned to this group pattern model. Based on this ensemble score, prediction module 160 determines whether to perform one or more actions 165. For example, prediction module 160 compares an ensemble score for a matching pattern with a plurality of ensemble score thresholds and performs an action corresponding to a threshold that the ensemble score satisfies.

### Example Group Pattern Models

FIG. 6 is a diagram illustrating example group pattern models. In the illustrated embodiment, several example group pattern models 620 are shown. In various embodiments, computer system 110 utilizes models (which may also be referred to herein as patterns) such as group pattern models 620 to evaluate new requests (such as requests 112 shown in FIG. 1). As discussed above, computer system 110 (shown in FIG. 1.) performs a comparison of group pattern models 620 to an electronic communication request 112 in an online manner (e.g., real-time with receiving the request).

In the illustrated embodiment, model A includes a set of three conditions and several group output values. For example, model A includes the following three conditions: (1) an email domain that is an exact match for “computers.com”, (2) an account creation date of “2024-04-09”, and (3) an item name of “notepad”. In addition, model A includes six different outputs, each of which is a number that is output when an electronic communication matches one or more conditions of model A. In some embodiments, computer system 110 (shown in FIG. 1) performs a secondary evaluation after obtaining model output corresponding to a matching model. As one example, if the gibberish email rate of a model C is not 1.0 but is approximately 0.5 (50%) of the emails included in nodes corresponding to the model C, then it is possible that an electronic communication that matches model C is not a suspicious or risky communication.

Similarly, in the illustrated embodiment, model B includes a set of two conditions and four group output values. For example, model B includes the following two conditions: (1) an email domain that is an exact match for “bikes.com” and (2) an item name of “bike”. In addition, model B includes four different outputs, each of which is a number that is output when an electronic communication matches one or more conditions of model B. For example, the output of model B includes: an account number count of 95, a medium communication number count of 5.1, a spike intensity score of 0.50 (e.g., a spike in the number of communications within a given time interval), and an ensemble score of 0.87 (e.g., indicating that this group pattern is modeling after a suspicious or anomalous group of nodes, since this value is close to 1).

### Example Methods

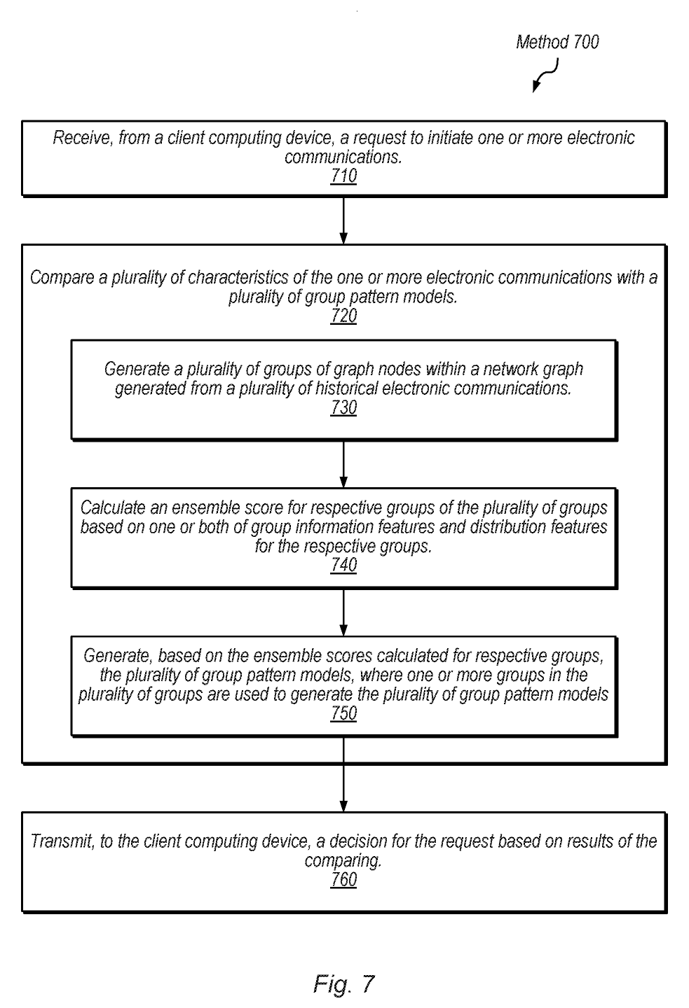

FIG. 7 is a flow diagram illustrating an example method for real-time predictions for electronic communications using previously generated group pattern models, according to some embodiments. The method 700 shown in FIG. 7 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In some embodiments, computer system 110 performs the elements of method 700.

At 710, in the illustrated embodiment, a computer system receives, from a client computing device, a request to initiate one or more electronic communications. In some embodiments, the electronic communications are electronic transactions. For example, an electronic communication may be an invoice.

At 720, the computer system compares a plurality of characteristics of the one or more electronic communications with a plurality of group pattern models. In some embodiments, the plurality of characteristics for a given electronic communication include one or more of the following: one or more devices involved in the given electronic communication, text descriptions, account profile information for one or more accounts participating in the given electronic communication, and Internet Protocol (IP) address, browser type, communication amount (e.g., transaction amount), etc.

At 730, the plurality of group pattern models are generated by generating a plurality of groups of graph nodes within a network graph generated from a plurality of historical electronic communications. In some embodiments, the network graph is a heterogeneous communication network graph including a plurality of nodes. In some embodiments, the computer system accesses, from a transaction database, communication data for a plurality of prior electronic communications. In some embodiments, the computer system generates, based on the plurality of prior electronic communications, the heterogeneous communication network graph, where the graph nodes store different types of communication data. In some embodiments, generating the plurality of groups of graph nodes is performed based on one or more of the following types of electronic communication data included in the network graph: a device fingerprint, context variables including text descriptions, and account profile keys

At 740, the plurality of group pattern models are generated by calculating an ensemble score for respective groups of the plurality of groups based on one or both of group information features and distribution features for the respective groups. In some embodiments, the group information features for a given group include one or both of a number of entities in the given group and a number of accounts in the given group. In some embodiments, the distribution features include a feature indicating a distribution of timestamps for historical electronic communications and a feature indicating the distribution of time between historical electronic transactions. In some embodiments, the computer system calculates the feature indicating the distribution of timestamps for respective groups in the plurality of groups. In some embodiments, the feature indicating the distribution of timestamps is a Gini coefficient.

In some embodiments, calculating the ensemble score is further performed based on domain features. In some embodiments, the domain features include one or more of the following features: a rate of new entities in a given group, a rate of gibberish email addresses in the given group, and a rate at which a country and Internet Protocol (IP) address match in respective nodes of the given group.

At 750, the plurality of group pattern models are generated by generating, based on the ensemble scores calculated for respective groups, the plurality of group pattern models, where one or more groups in the plurality of groups are used to generate the plurality of group pattern models. For example, group pattern models are illustrated in FIG. 6 and discussed in detail above.

At 760, the computer system transmits, to the client computing device, a decision for the request based on results of the comparing. In some embodiments, the decision specifies that the requested electronic communication has been rejected. In other embodiments, the decision specifies that the requested electronic communication has been approved and completed by the computer system. In some embodiments, the computer system is a server system.

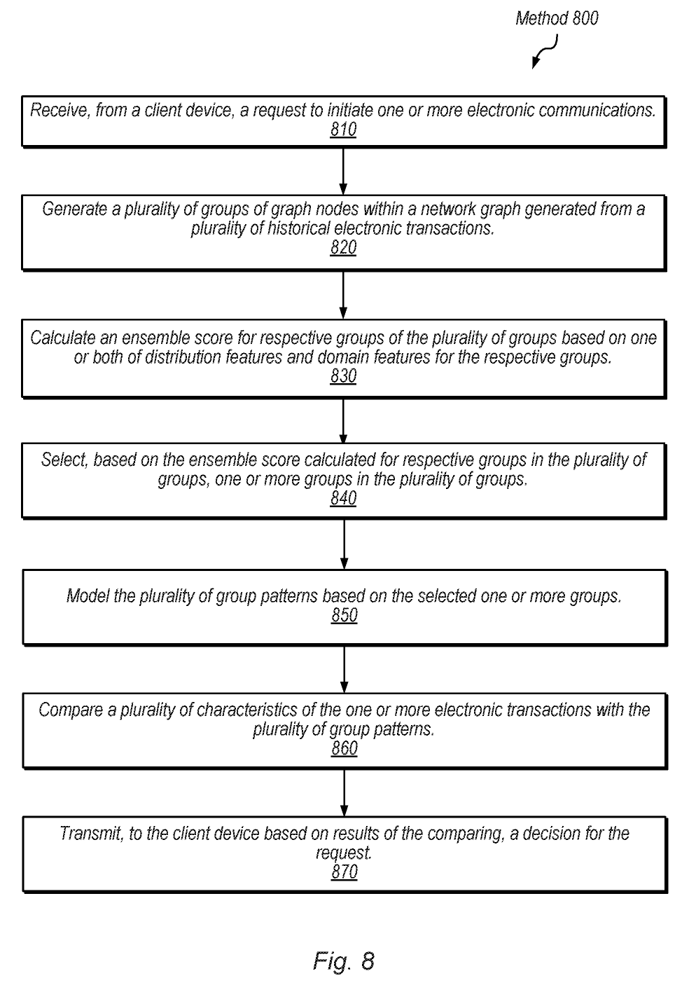

FIG. 8 is a flow diagram illustrating an example method for method for generating and utilizing group patterns for electronic transaction decisioning, according to some embodiments. The method 800 shown in FIG. 8 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In some embodiments, computer system 110 performs the elements of method 800.

At 810, in the illustrated embodiment, a computing system receives, from a client device, a request to initiate one or more electronic transactions. In various embodiments, the request specifies one or more invoices, payments, person-to-person transaction, etc.

At 820, the computing system generates a plurality of groups of graph nodes within a network graph generated from a plurality of historical electronic transactions. In some embodiments, the network graph is a heterogeneous transaction network graph. In some embodiments, the computing system accesses, from a transaction database, transaction data for a plurality of prior electronic transactions. In some embodiments, the computing system generates, based on the plurality of prior electronic transaction, the heterogeneous transaction network graph, where the graph nodes store different types of data, including two or more of the following types of data: a device fingerprint, transaction context variables including text descriptions, and account profile keys.

In some embodiments, the computing system generates the device fingerprint for the client device based on one or more attributes of the following types of attributes: Internet protocol (IP) address, a hash value of a device ID of the client device, type of the client device, a browser type utilized at the client device, application used to submit the request, phone number, geographic time zone, geographic location, country code, a name of the client device, a language corresponding to the request, screen pixels of the client device, and a globally unique identifier GUID).

At 830, the computing system calculates an ensemble score for respective groups of the plurality of groups based on one or both of distribution features and domain features for the respective groups. In some embodiments, the distribution features include a feature indicating a distribution of timestamps for historical electronic transactions and a feature indicating the distribution of time between electronic transactions in a given group of the plurality of groups. In some embodiments, the computing system calculates, using a Poisson process, the feature indicating the distribution of time between electronic transactions in the given group. In some embodiments, calculating the ensemble score is further performed based on group information features.

At 840, the computing system selects, based on the ensemble score calculated for respective groups in the plurality of groups, one or more groups in the plurality of groups. In some embodiments, selecting the one or more groups based on their respective ensemble scores includes determining that the ensemble score for respective ones of the one or more groups satisfy a confidence threshold corresponding to a high classification confidence. For example, if a group has a high ensemble score, then this group is likely to be used to model risky electronic communications for comparison to future newly requested electronic communications.

At 850, the computing system models the plurality of group patterns based on the selected one or more groups. In some embodiments, the selected one or more groups represent electronic communications that are anomalous (e.g., risky or suspicious) in some way. In some embodiments, modeling the plurality of group patterns includes generating a plurality of group pattern conditions. In some embodiments, the plurality of group pattern conditions are group pattern models that are generated by training, using the one or more groups in the plurality of groups, a machine learning model to identify newly requested electronic communications that are similar to the one or more groups.

At 860, the computing system transmits, to the client device based on results of the comparing, a decision for the request. In some embodiments, the decision for the request specifies that the request is denied at least until the client device provides authentication information for a user requesting the one or more transactions. For example, the decision may specify one or more authentication factors that are required before the request can be approved by the computing system.

In addition to methods 700 and 800 and its variants, non-transitory, computer-readable media storing program instructions executable to implement such methods are also contemplated, along with systems configured to implement these methods.

***

The various techniques described herein may be performed by one or more computer programs. The term “program” is to be construed broadly to cover a sequence of instructions in a programming language that a computing device can execute. Database system 110, shown in FIG. 1, may also be referred to herein as a “computer system” and is one example of the computing device that may execute various sequences of instructions that make up a program. These programs may be written in any suitable computer language, including lower-level languages such as assembly and higher-level languages such as Python. The program may be written in a compiled language such as C or C++, or an interpreted language such as JavaScript.

Program instructions may be stored on a “computer-readable storage medium” or a “computer-readable medium” to facilitate execution of the program instructions by a computer system, such as database system 110 or one or more computer systems 102. Generally speaking, these phrases include any tangible or non-transitory storage or memory medium. The terms “tangible” and “non-transitory” are intended to exclude propagating electromagnetic signals, but not to otherwise limit the type of storage medium. Accordingly, the phrases “computer-readable storage medium” or a “computer-readable medium” are intended to cover types of storage devices that do not necessarily store information permanently (e.g., random access memory (RAM)). The term “non-transitory,” accordingly, is a limitation on the nature of the medium itself (i.e., the medium cannot be a signal) as opposed to a limitation on data storage persistency of the medium (e.g., RAM vs. ROM).

The phrases “computer-readable storage medium” and “computer-readable medium” are intended to refer to both a storage medium within a computer system as well as a removable medium such as a CD-ROM, memory stick, or portable hard drive. These phrases cover any type of volatile memory within a computer system including DRAM, DDR RAM, SRAM, EDO RAM, Rambus RAM, etc., as well as non-volatile memory such as magnetic media, e.g., a hard drive, or optical storage. The phrases are explicitly intended to cover the memory of a server that facilitates downloading of program instructions, the memories within any intermediate computer system involved in the download, as well as the memories of all destination computing devices. Still further, the phrases are intended to cover combinations of different types of memories.

In addition, a computer-readable medium or storage medium may be located in a first set of one or more computer systems in which the programs are executed, as well as in a second set of one or more computer systems which connect to the first set over a network. In the latter instance, the second set of computer systems may provide program instructions to the first set of computer systems for execution. In short, the phrases “computer-readable storage medium” and “computer-readable medium” may include two or more media that may reside in different locations, e.g., in different computers that are connected over a network.

Note that in some cases, program instructions may be stored on a storage medium but not enabled to execute in a particular computing environment. For example, a particular computing environment (e.g., a first computer system such as computer system 110) may have a parameter set that disables program instructions that are nonetheless resident on a storage medium of the first computer system. The recitation that these stored program instructions are “capable” of being executed is intended to account for and cover this possibility. Stated another way, program instructions stored on a computer-readable medium can be said to be “executable” to perform certain functionality, whether or not current software configuration parameters permit such execution. Executability means that when and if the instructions are executed, they perform the functionality in question.

The present disclosure refers to various software operations that are performed in the context of one or more computer systems. Graph module 120, group scoring module 130, deployment module 140, and prediction module 160 can each execute on respective computer systems, for example. Similarly, electronic communication database 150 can be implemented on the same computer system or a different computer systems than the modules 120, 130, 140, and 160. For example, modules 120, 130, 140, and prediction module 160 may be implemented by a first computer system and electronic communication database 150 may be implemented by a second, different database system. Each of these components, then, is implemented on physical structure (i.e., on computer hardware).

In general, any of the services or functionalities of a software development environment described in this disclosure can be performed by a host computing device, which is any computer system, such as computer system 110, that is capable of connecting to a computer network. A given host computing device can be configured according to any known configuration of computer hardware. A typical hardware configuration includes a processor subsystem, memory, and one or more I/O devices coupled via an interconnect. For example, computer system 110 receives requests 112 from one or more client computing devices 102 via an interconnect corresponding to an I/O device of computer system 110 and stores data in a memory, such as electronic communication database 150, as shown in FIG. 1. A given host computing device may also be implemented as two or more computer systems operating together.

The processor subsystem of the host computing device may include one or more processors or processing units. In some embodiments of the host computing device, multiple instances of a processor subsystem may be coupled to the system interconnect. The processor subsystem (or each processor unit within a processor subsystem) may contain any of various processor features known in the art, such as a cache, hardware accelerator, etc.

The system memory of the host computing device is usable to store program instructions executable by the processor subsystem to cause the host computing device to perform various operations described herein. The system memory may be implemented using different physical, non-transitory memory media, such as hard disk storage, floppy disk storage, removable disk storage, flash memory, random access memory (RAM—SRAM, EDO RAM, SDRAM, DDR SDRAM, RAMBUS RAM, etc.), read-only memory (PROM, EEPROM, etc.), and so on. Memory in the host computing device is not limited to primary storage. Rather, the host computing device may also include other forms of storage such as cache memory in the processor subsystem and secondary storage in the I/O devices (e.g., a hard drive, storage array, etc.). In some embodiments, these other forms of storage may also store program instructions executable by the processor subsystem.

The interconnect of the host computing device may connect the processor subsystem and memory with various I/O devices. One possible I/O interface is a bridge chip (e.g., Southbridge) from a front-side to one or more back-side buses. Examples of I/O devices include storage devices (hard drive, optical drive, removable flash drive, storage array, SAN, or their associated controller), network interface devices (e.g., to a computer network), or other devices (e.g., graphics, user interface devices.

***

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of … w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of … w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
receiving, by a computer system from a client computing device, a request to initiate one or more electronic communications;
comparing, by the computer system, a plurality of characteristics of the one or more electronic communications with a plurality of group pattern models, wherein the plurality of group pattern models are generated by:
generating a plurality of groups of graph nodes within a network graph generated from a plurality of historical electronic communications;
calculating an ensemble score for respective groups of the plurality of groups based on one or both of group information features and distribution features for the respective groups;
generating, based on the ensemble scores calculated for respective groups, the plurality of group pattern models, wherein one or more groups in the plurality of groups are used to generate the plurality of group pattern models; and
transmitting, by the computer system to the client computing device, a decision for the request based on results of the comparing.

2. The method of claim 1, wherein calculating the ensemble score is further performed based on domain features.

3. The method of claim 2, wherein the domain features include one or more of the following features: a rate of new entities in a given group, a rate of gibberish email addresses in the given group, and a rate at which a country and Internet Protocol (IP) address match in respective nodes of the given group.

4. The method of claim 1, wherein the group information features for a given group include one or both of a number of entities in the given group and a number of accounts in the given group.

5. The method of claim 1, wherein the distribution features include a feature indicating a distribution of timestamps for historical electronic communications and a feature indicating the distribution of time between historical electronic transactions.

6. The method of claim 5, further comprising:
calculating, by the computer system, the feature indicating the distribution of timestamps for respective groups in the plurality of groups, wherein the feature indicating the distribution of timestamps is a Gini coefficient.

7. The method of claim 1, wherein the network graph is a heterogeneous communication network graph including a plurality of nodes, and wherein the method further comprises:
accessing, by the computer system from a transaction database, communication data for a plurality of prior electronic communications; and
generating, by the computer system based on the plurality of prior electronic communications, the heterogeneous communication network graph, wherein the graph nodes store different types of communication data.

8. The method of claim 1, wherein generating the plurality of groups of graph nodes is performed based on one or more of the following types of electronic communication data included in the network graph: a device fingerprint, context variables including text descriptions, and account profile keys.

9. A non-transitory, computer-readable medium having program instructions stored thereon that are executable by a computing system to perform operations comprising:
receiving, from a client device, a request to initiate one or more electronic transactions;
generating a plurality of groups of graph nodes within a network graph generated from a plurality of historical electronic transactions;
calculating an ensemble score for respective groups of the plurality of groups based on one or both of distribution features and domain features for the respective groups;
selecting, based on the ensemble score calculated for respective groups in the plurality of groups, one or more groups in the plurality of groups;
modeling a plurality of group patterns based on the selected one or more groups;
comparing a plurality of characteristics of the one or more electronic transactions with the plurality of group patterns; and
transmitting, to the client device based on results of the comparing, a decision for the request.

10. The non-transitory computer-readable medium of claim 9, wherein the network graph is a heterogeneous transaction network graph, and where the operations further comprise:
accessing, from a transaction database, transaction data for a plurality of prior electronic transactions; and
generating, based on the plurality of prior electronic transaction, the heterogeneous transaction network graph, wherein the graph nodes store different types of data, including two or more of the following types of data: a device fingerprint, transaction context variables including text descriptions, and account profile keys.

11. The non-transitory computer-readable medium of claim 10, wherein the operation further comprise:
generating the device fingerprint for the client device, wherein the device fingerprint is generated based on one or more attributes of the following types of attributes: Internet protocol (IP) address, a hash value of a device ID of the client device, type of the client device, a browser type utilized at the client device, application used to submit the request, phone number, geographic time zone, geographic location, country code, a name of the client device, a language corresponding to the request, screen pixels of the client device, and a globally unique identifier GUID).

12. The non-transitory computer-readable medium of claim 9, wherein the distribution features include a feature indicating a distribution of timestamps for historical electronic transactions and a feature indicating the distribution of time between electronic transactions in a given group of the plurality of groups.

13. The non-transitory computer-readable medium of claim 12, wherein the operations further comprise:
calculating, using a Poisson process, the feature indicating the distribution of time between electronic transactions in the given group.

14. The non-transitory computer-readable medium of claim 9, wherein calculating the ensemble score is further performed based on group information features, and wherein selecting the one or more groups based on their respective ensemble scores includes:
determining that the ensemble score for respective ones of the one or more groups satisfy a confidence threshold corresponding to a high classification confidence.

15. A system comprising:
a processor; and
a non-transitory computer-readable medium having stored thereon instructions that are executable by the processor to cause the system to perform operations comprising:
receiving, from a client computer, a request to initiate one or more electronic communications;
comparing a plurality of characteristics of the one or more electronic communications with a plurality of group pattern conditions, wherein the plurality of group pattern conditions are generated by:
generating a plurality of groups of graph nodes within a network graph generated from a plurality of historical electronic communications;
calculating an ensemble score for respective groups of the plurality of groups based on one or both of group information features and domain features for the respective groups;
generating, based on the ensemble scores calculated for respective groups, the plurality of group pattern conditions, wherein one or more groups in the plurality of groups are used to generate the plurality of group pattern conditions; and
transmitting, to the client computer, a decision for the request based on results of the comparing.

16. The system of claim 15, wherein calculating the ensemble score is further performed based on distribution features that include a feature indicating a distribution of timestamps for historical electronic communications and a feature indicating the distribution of time between historical electronic transactions.

17. The system of claim 16, wherein the instructions are further executable by the processor to cause the system to perform operations comprising
calculating the feature indicating the distribution of timestamps for respective groups in the plurality of groups, wherein the feature indicating the distribution of timestamps is a Gini coefficient.

18. The system of claim 15, wherein the graph nodes store different types of transaction data, including two or more of the following: a device fingerprint generated based on an IP address and a time zone of the client computer, transaction context variables including text descriptions, and account profile keys.

19. The system of claim 15, wherein the domain features include one or more of the following features: a rate of new entities in a given group, a rate of gibberish email addresses in the given group, and a rate at which a country and Internet Protocol (IP) address match in respective nodes of the given group.

20. The system of claim 15, wherein the plurality of group pattern conditions are group pattern models that are further generated by:
training, using the one or more groups in the plurality of groups, a machine learning model to identify newly requested electronic communications that are similar to the one or more groups.
